(19) United States
(12) Patent Application Publication
(10) Pub. No.: US 2004/0150625 A1
(43) Pub. Date: Aug. 5, 2004

(54) Virtual keyboard and mouse control device

(76) Inventors: Ching-Chih Shih, Tao Yuan Shien (TW); Pi-Cheng Chen, Hsin Chuang City (TW); Shin-Yun Lin, Taipei (TW); Wen-Yuan Hung, Hsintien City (TW)

Correspondence Address: RABIN & BERDO, P.C., Suite 500, 1101 14th Street, N.W., Washington, DC, 20005, US

(21) Appl. No.: 10/446,938

(22) Filed: May 29, 2003

(30) Foreign Application Priority Data
Jan. 30, 2003 (TW) 92102343

(51) Int. Cl. G09G 5/00

(52) U.S. Cl. 345/168

(57) ABSTRACT

A virtual keyboard and mouse control device is described. The control device controls a server with a keyboard and a mouse of a remote computer via a network. The control device includes an input interface, a transformation device, a first output interface and a second output interface. The input interface receives packets from the remote computer via the network. The transformation device transforms the packets into mouse output signals and keyboard output signals according to the input specification of the server to simulate a local keyboard and a local mouse. The first output interface sends the keyboard output signals to the server and the second output interface sends the mouse output signals to the server. The first and second output interface includes a universal serial bus, an IEEE 1394 bus or a PS/2 input/output port.

### FIELD OF THE INVENTION

The present invention relates to use of a virtual keyboard and mouse as a control device to control a server computer via a network and especially to use of a remote keyboard and mouse via a network to control a server computer without a working operating system (OS).

### BACKGROUND OF THE INVENTION

Computers have been widely applied in all fields, and network technologies have rapidly progressed. Therefore, people can easily access information and provide services by way of networks, and the growing network provides people with a comfortable and fast information environment.

At this time, there is a lot of information to be distributed over the network. Therefore, a network established with only few computers provides insufficient service. Network systems are established with more computers and the computer apparatuses may even be distributed over different places all over the world. The computer apparatuses, such as workstations, servers, database memory, routers, and backup devices, connect with each other via the network so as to provide diverse services.

At this stage, people controlling the server computer via the network have to install a remote control software based on a working operating system (OS). For this management method, an OS, such as the Windows operating system, supporting the network must already be installed in a computer. That is to say, the remote computers can control the server computers via the network only if the server computers and the remote computers use the OS supporting the network and the remote control software.

But if a server computer is using a non-network support OS, such as the disk operating system (DOS), or a server computer has not run an OS supporting network, the remote computer cannot access the server computer and cannot control the server computer with the keyboard and mouse of the remote computer via the network. Accordingly, there is a control breach for remotely controlling server computers via the network.

### SUMMARY OF THE INVENTION

One object of the present invention is to provide a virtual keyboard and mouse as a control device to remotely control server computers via a network. The control device transforms signals of the keyboard and mouse of the remote computer into signals of the keyboard and mouse of a local server computer so that even a local server computer without a working operating system can be directly controlled by the keyboard and mouse of the remote computer. Furthermore, the local server computer can reinstall the operating system, reboot, and set up the basic input/output system thereof by way of the remote computer and the network.

Another object of the present invention is to provide a control device including a virtual keyboard and mouse that can simulate the track signals of the keyboard and mouse to test automatically the server computer.

The present invention provides a control device of a virtual keyboard and mouse. The control device connects to a server computer and a remote computer via a network. Therefore, a mouse and a keyboard of the remote computer can be simulated as a mouse and a keyboard of the server computer for direct control and management of the server computer. The control device comprises an input interface, a transformation device, a first output interface, and a second output interface. The input interface connects to the network for receiving network packets generated from the remote computer. The transformation device transforms the network packets into mouse output signals and keyboard output signals according to respective input specifications of the server computer and transmits these signals to the first output interface and second output interface. The first output interface, such as a universal serial bus (USB) signal output interface or a PS/2 signal output interface, connects to the transformation device and a mouse connector of the server computer for transmitting the mouse output signals to the mouse connector to control the server computer. The second output interface, such as a USB signal output interface or a PS/2 signal output interface, connects to the transformation device and a keyboard connector of the server computer for transmitting the keyboard output signals to the keyboard connector to control the server computer.

The transformation device further comprises a hub, a central processing unit, a programmable integrated circuit, a keyboard signal transformation device, a mouse signal transformation device, and a network interface card (NIC). The hub connects to a corresponding input/output port of the server computer. The central processing unit receives input network packets generated by the remote computer via the network and decodes the same. The programmable integrated circuit subsequently transforms the decoded input network packets into respective mouse signals and keyboard signals. By way of the keyboard signal transformation device, the keyboard signals further transform into USB keyboard output signals and PS/2 keyboard output signals when the hub is a USB hub and the server computer uses a PS/2 connector for keyboard.

By way of the mouse signal transformation device, the mouse signals further transform into USB mouse output signals and PS/2 mouse output signals when the hub is a USB hub and the server computer uses a PS/2 connector for mouse. The network interface card connects the central processing unit to the network for receiving the network packets. The hub can be any hub with series connection capability.

Hence, the virtual keyboard and mouse control device according to the present invention can simulate the mouse and keyboard of the remote computer as the mouse and keyboard of the local server computer. By way of network, the server computer supervisor can utilize the keyboard and mouse of the remote computer for direct control and management of the server computer, even if the server computer lacks an operating system.

### BRIEF DESCRIPTION OF THE DRAWING

The foregoing aspects and many of the attendant advantages of this invention will be more readily appreciated as the same becomes better understood by reference to the following detailed description, when taken in conjunction with the accompanying drawings, wherein:

FIG. 1 is a schematic network architecture of a preferred embodiment with a virtual keyboard and mouse control device according to the present invention; and

FIG. 2 is a block diagram of a virtual keyboard and mouse control device according to the present invention.

### DETAILED DESCRIPTION OF THE PREFERRED EMBODIMENT

The following description is the best presently contemplated mode of carrying out the present invention. This description is not to be taken in a limiting sense but is made merely for the purpose of describing the general principles of the invention. The scope of the invention should be determined by referencing the appended claims.

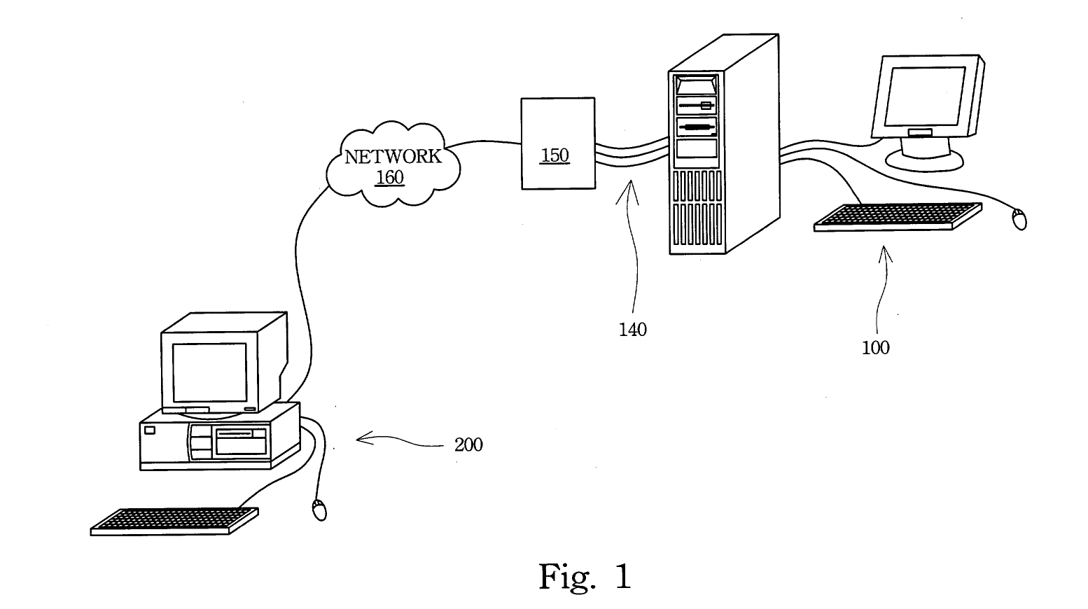

FIG. 1 is a schematic network architecture of a preferred embodiment with a virtual keyboard and mouse control device according to the present invention. A keyboard and mouse of a remote computer 200 can remotely control the server computer 100 by way of the virtual keyboard and mouse control device 150 according to the present invention and the network 160. A connecting cable 140 connects the virtual keyboard and mouse control device 150 to the server computer 100. The connecting cable 140 includes a universal serial bus (USB) cable, PS/2 cable, or any normal computer input/output cables.

With the virtual keyboard and mouse control device 150 according to the present invention, the computer system can use the keyboard and mouse of the remote computer 200 to control the server computer 100. Further, by way of the virtual keyboard and mouse control device 150, the keyboard and mouse of the remote computer 200 can always control the server computer 100 whether the server computer is working with or without an operating system which supports the network or not. Furthermore, whether or not the server computer 100 is running an operating system, the remote computer 200 can remotely control the server computer 100 even when the server computer reboots or sets up the BIOS thereof. In any situation of the server computer 100, with virtual keyboard and mouse control device 150 according to the present invention, the keyboard and mouse of the remote computer 200 can always control the server computer 100 via the network 160.

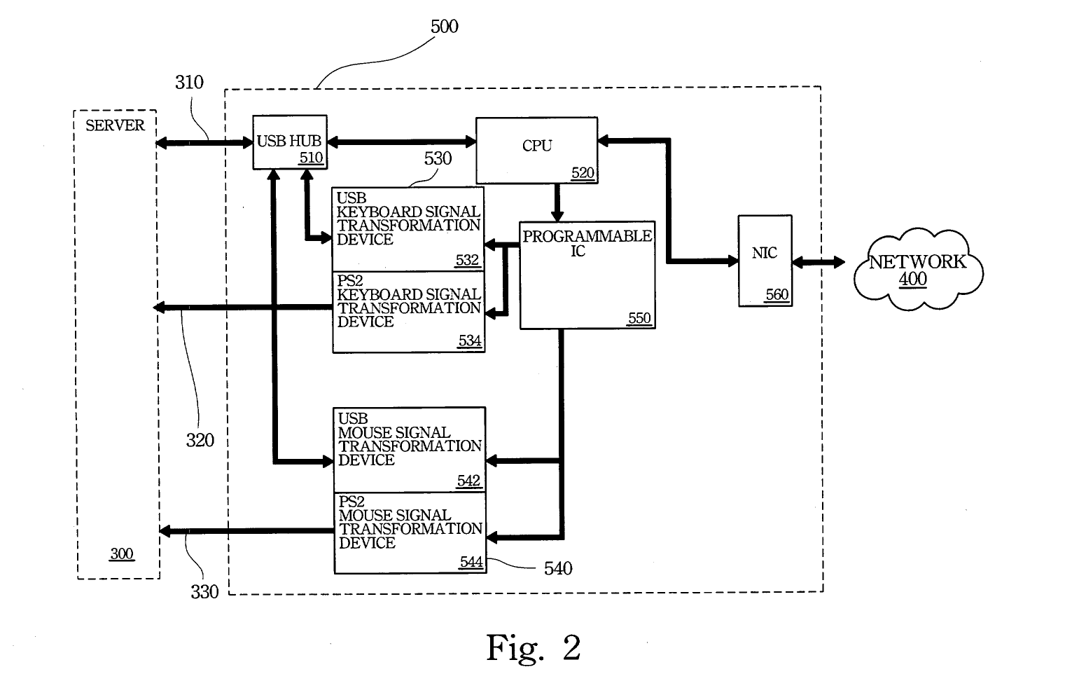

FIG. 2 is a block schematic diagram of a virtual keyboard and mouse control device according to the present invention. The following detailed description illustrates functions and theories of the control device of the present invention with reference to FIG.2. The virtual keyboard and mouse control device 500 connect to the server 300 by a USB cable 310 and PS/2 cable 320 and 330. The control device 500 further connects to a remote computer via the network 400 for controlling the server 300.

The control device 500 includes a USB hub 510, a central processing unit (CPU) 520, a keyboard signal transformation device 530, a mouse signal transformation device 540, a programmable integrated circuit (IC) 550, and a network interface card (NIC) 560. The keyboard signal transformation device 530 further comprises a USB keyboard signal transformation device 532 and a PS/2 keyboard signal transformation device 534. The mouse signal transformation device 540 further comprises a USB mouse signal transformation device 542 and a PS/2 mouse signal transformation device 544. The USB keyboard signal transformation device 532 and the USB mouse signal transformation device 542 connect to the USB hub 510, and the USB hub 510 further connects to a USB port of the server 300 with the USB cable 310. The PS/2 keyboard signal transformation device 534 connects to a keyboard PS/2 port of the server 300 with a PS/2 cable 320. The PS/2 mouse signal transformation device 544 connects to a mouse PS/2 port of the server 300 with a PS/2 cable 330.

USB hub 510 connects to the CPU 520, and the CPU 520 further connects to the NIC 560 and the programmable IC 550. Subsequently, the programmable IC 550 connects to the keyboard signal transformation device 530 and the mouse signal transformation device 540, and therefore the programmable IC 550 output signals can be directly transmitted to the USB keyboard signal transformation device 532, the PS/2 keyboard signal transformation device 534, the USB mouse signal transformation device 542 or the PS/2 mouse signal transformation device 544.

The following description will illustrate functions and working processes of the foregoing disclosed preferred embodiment and is given to enable a person skilled in the art to realize the sprit of the present invention rather than to limit the present invention.

If a server supervisor is working at a remote computer and wants to control a server computer via a network, the supervisor needs to utilize either a predetermined application program installed in the remote computer or a browser program supporting Java applets to control the server computer. If the remote computer uses the predetermined application program, the remote computer has to install the predetermined application program before controlling the server computer, and if the remote computer uses the browser with Java applet support, the remote computer only needs to connect to the virtual keyboard and mouse control device according to the present invention via the network and the remote computer can directly download the management applet from the control device and immediately control the server computer.

By using either the predetermined application program installed in the remote computer or the management applet downed from the control device, the remote computer can directly remote control the server computer and transform the keyboard and mouse signals into network packets according to the communication protocol while the remote computer already accesses the control device. The network packets of the keyboard and mouse signals of the remote computer therefore transmit to the control device by way of the network.

The virtual keyboard and mouse control device according to the present invention receives the network packets of the keyboard and mouse signals from the remote computer. The CPU 520 with an internal agent software then decodes the network packets and informs the programmable IC 550 which device sends these network packets, for example, a mouse, a keyboard, or both. Subsequently, the programmable IC 550 utilizes a transformation software to simulate the real mouse and keyboard track signals, that is to say, the programmable IC 550 reproduces the remote mouse and keyboard track signals as a virtual mouse and keyboard in the control device 500. These real mouse and keyboard track signals are then transmitted to the keyboard signal transformation device 530 and the mouse signal transformation device 540. Therefore, these practical mouse and keyboard track signals further transform into respective USB and PS/2 signals for transmission to the server 300. For example, the USB keyboard signal transformation device 532 and the USB mouse signal transformation device 542 transfer the real keyboard and mouse track signals into the USB output signals and then send the same to the server 300 by way of the USB hub 510 and the USB cable 310. The PS/2 keyboard signal transformation device 534 and the PS/2 mouse signal transformation device 544 transfer the real keyboard and mouse track signals into the PS/2 output signals and then send the same to the server 300 by way of the PS/2 cable 320 and 330.

As a result of the control device of the present invention reproducing the mouse and keyboard track signals of the remote computer to simulate a keyboard and a mouse directly connected to the server computer, the keyboard and mouse of the remote computer are similar to a virtual keyboard and mouse of the server computer. Therefore, the virtual keyboard and mouse can work with the server computer in any working process, such as reboot, reinstallation the operating system and BIOS setup. Even if the working process does not support the network environment, the remote computer can still control the server computer through the control device according to the present invention.

Hence, with the virtual keyboard and mouse control device according to the present invention, the server computer need not run an operating system for remote control thereof. The present invention effectively improves the remote control function of the server computer. By way of the control device of the present invention, the server computer can be controlled at anytime, and especially to restart the server computer and setup the BIOS. The present invention provides a remote control device without any control breach to improve effectively the traditional network server management.

In the meantime, a test engineer can record a keyboard and mouse signals to a macro program and send the same to the control device of the present invention. These signals can then be resent to the server computer for repeated automatic testing of the server computer. The USB hub and network interface card in the present invention can use an internal type or an external type; the present invention is not limited to the internal type. The hub can be any hub including series connection capacity; for example, an IEEE 1394 hub also works for the present invention. As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A virtual keyboard and mouse control device connecting to a server computer and a remote computer via a network, the control device comprising:
a hub connected to an input/output port of the server computer;
a central processing unit disposed between the hub and the network, the central processing unit receiving and decoding input network packets generated by the remote computer via the network;
a programmable integrated circuit connected to the central processing unit and transforming the decoded input network packets into respective mouse signals and keyboard signals;
a keyboard signal transformation device connected to the programmable integrated circuit, the keyboard signal transformation device comprising a first keyboard signal output interface connected to the hub and a second keyboard signal output interface connected to a keyboard signal input connector of the server computer, the keyboard signal transformation device transforming the keyboard signals into first keyboard output signals according to a hub specification or second keyboard output signals according to a keyboard signal input connector specification;
a mouse signal transformation device connected to the programmable integrated circuit, the mouse signal transformation device comprising a first mouse signal output interface connected to the hub and a second mouse signal output interface connected to a mouse signal input connector of the server computer, the mouse signal transformation device transforming the mouse signals into first mouse output signals according to the hub specification or second mouse output signals according to a mouse signal input connector specification.

2. The control device of claim 1, wherein the control device further comprises a network interface card between the central processing unit and the network.

3. The control device of claim 1, wherein the hub comprises a bus hub with series connection capability.

4. The control device of claim 3, wherein the bus hub comprises a universal serial bus hub (USB Hub).

5. The control device of claim 1, wherein the second keyboard output signals comprise PS/2 keyboard output signals.

6. The control device of claim 1, wherein the second mouse output signals comprise PS/2 mouse output signals.

7. A virtual input/output control device connecting to a server computer and a remote computer via a network, the virtual input/output control device comprising:
a hub connected to an input/output port of the server computer;
a central processing unit disposed between the hub and the network, the central processing unit receiving input network packets generated by the remote computer via the network and decoding the input network packets;
a programmable integrated circuit connected to the central processing unit and transforming the decoded input network packets into mouse signals and keyboard signals; and
a transformation device connected to the programmable integrated circuit, the transformation device comprising an output interface connected to the hub and the transformation device transforming the mouse signals and keyboard signals into respectively corresponding mouse output signals and keyboard output signals according to a hub specification.

8. The virtual input/output control device of claim 7, wherein the virtual input/output control device further comprises a network interface card between the central processing unit and the network.

9. The virtual input/output control device of claim 7, wherein the hub comprises a bus hub with series connection capability.

10. The virtual input/output control device of claim 9, wherein the bus hub comprises a universal serial bus hub (USB Hub).

11. The virtual input/output control device of claim 7, wherein the transformation device is a keyboard signal transformation device or a mouse signal transformation device.

12. The virtual input/output control device of claim 7, wherein the transformation device further comprises a second output interface connected to a connector of the server computer.

13. The virtual input/output control device of claim 12, wherein the transformation device further transforms the mouse signals and keyboard signals into respectively corresponding second mouse output signals and second keyboard output signals according to a connector specification.

14. The virtual input/output control device of claim 13, wherein the second mouse output signals comprise PS/2 mouse input/output signals.

15. The virtual input/output control device of claim 13, wherein the second keyboard output signals comprise PS/2 keyboard input/output signals.

16. A virtual keyboard and mouse control device, the control device connected to a server computer and a remote computer via a network, the control device comprising:
an input interface connected to the network for receiving network packets generated by the remote computer;
a transformation device connected to the input interface to transform the network packets into mouse output signals and keyboard output signals according to respective input specifications of the server computer for controlling the server computer;
a first output interface connected to the transformation device and a mouse connector of the server computer for transmitting the mouse output signals to the mouse connector to control the server computer; and
a second output interface connected to the transformation device and a keyboard connector of the server computer for transmitting the keyboard output signals to the keyboard connector to control the server computer.

17. The control device of claim 16, wherein the first output interface comprises a universal serial bus (USB) signal output interface.

18. The control device of claim 16, wherein the first output interface comprises a PS/2 signal output interface.

19. The control device of claim 16, wherein the second output interface comprises a universal serial bus (USB) signal output interface.

20. The control device of claim 16, wherein the second output interface comprises a PS/2 signal output interface.
